(19) United States
(12) Patent Application Publication
(10) Pub. No.: US 2002/0033106 A1
(43) Pub. Date: Mar. 21, 2002

(54) Web printers

(76) Inventors: Tetsuya Ohba, Hitachinaka (JP); Akitomo Kuwabara, Hitachinaka (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/927,391

(22) Filed: Aug. 13, 2001

(30) Foreign Application Priority Data
Aug. 18, 2000 (JP) 2000-248063

(51) Int. Cl. B41F 13/56

(52) U.S. Cl. 101/225

(57) ABSTRACT

A web printer having a buffer means for adjusting the traveling position of the web under its slack status, a tension assigning means for assigning fixed tension to the web delivered from the buffer means, a means for detecting the traveling position of the web delivered from the tension assigning means, a skew correction means for adjusting the skew of said web according to the output from the detection means, and an image forming means that forms images on the web.

### BACKGROUND OF THE INVENTION

1. Field of the Invention

The present invention relates to web printers that form images on the webs carried at high speed.

2. Related Background Art

In the general types of printers that form images on webs, the pin members of the tractor mechanism mounted on the printer are engaged with the feed holes of the web and the tractor mechanism is driven to feed the web and form an image thereon using the image forming section of the printer. After the web with the feed holes has been printed, however, these feed holes (usually, the left and right edges of the web) need to be cut and thus a time is spent in obtaining the final printed matter. Also, the printer itself requires a tractor mechanism as its mandatory component, and absolutely needs to take a complex configuration. Such cutting operation as mentioned above can be omitted by adopting webs free of feed holes, using a tractor mechanism, instead of the web feeder of the printer, and providing a web feed roller mechanism.

By the way, for a printer that uses webs free of feed holes and forms an image on a web while feeding it by use of a feed roller mechanism, if this printer is of the type up to a middle-speed region in which only about 50 pages per minute can be printed on an A4-paper horizontal feed basis, printing not conspicuous in terms of print position offsets is possible since not too significant slipping occurs between the web and the feed rollers. If, however, the printer is of the high-speed region type capable of printing more than 100 pages per minute or is of the ultrahigh-speed region type capable of printing more than 200 pages per minute, it is difficult under the conventional configuration to feed the web to the image forming section accurately, and even when such extremely thin paper as used for a dictionary, for example, is fed at a rate as high as more than 100 pages per minute, the need arises to control very accurately the tension, traveling position, etc. of the web being fed.

### SUMMARY OF THE INVENTION

The object of the invention is to provide a printer that enables, irrespective of the web type, stable feed of the web at high speed and with high accuracy.

The object set forth above can be achieved by obtaining a printer having

a buffer means for adjusting the traveling position of the web under its slack status,

a tension assigning means for assigning fixed tension to the web delivered from said buffer means,

a means for detecting the traveling position of the web delivered from said tension assigning means,

a skew correction means for adjusting the skew of said web according to the output from said detection means, and

an image forming means that forms images on the web delivered from said skew correction means.

### BRIEF DESCRIPTION OF THE DRAWINGS

FIG. 1 is a total block diagram of the printer shown as an embodiment of the present invention.

FIG. 2 is a view showing the configuration of the control section in the embodiment of FIG. 1.

FIG. 3 is a total block diagram of another embodiment of the present invention.

### DETAILED DESCRIPTION OF PREFERRED EMBODIMENTS

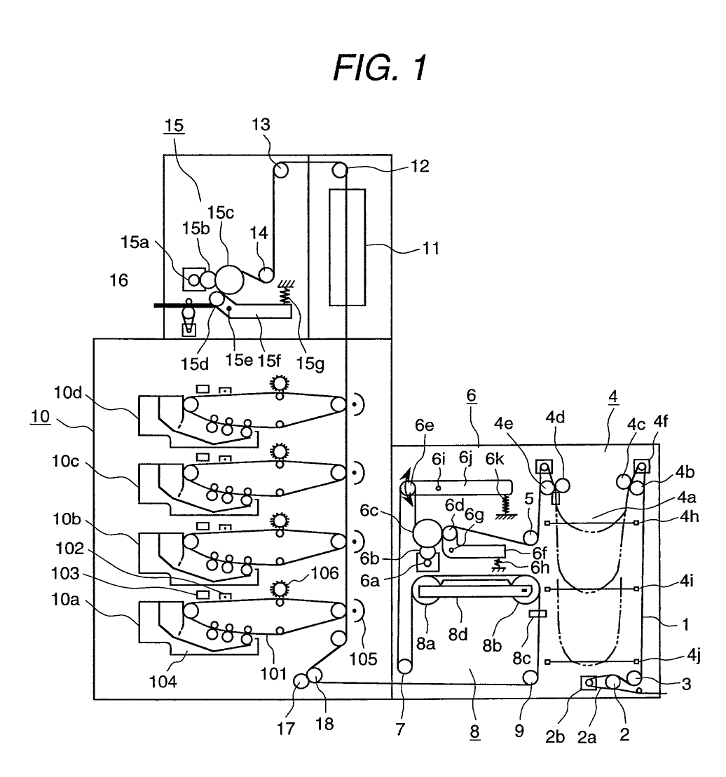

An embodiment of the present invention is described below using drawings. FIG. 1 is a schematic diagram showing an embodiment of the printer pertaining to the present invention.

Numeral 1 in FIG. 1 denotes a web. Web 1 may be made from paper, a plastic film, or the like. Web 1 is inducted into a buffer unit 4 via guide rollers 2 and 3 arranged on the web feed route; the guide roller 2 being connected to a motor 2b via a timing belt 2a and rotationally driven at a surface velocity higher than the feed rate of web 1 and in the same direction as the feed direction of the web.

The buffer unit 4 is equipped with a storage portion 4a for temporarily storing the web 1 fed, one pair of rollers 4b and 4c provided at the web loading section with respect to the storage portion 4a, one pair of rollers 4d and 4e provided at the web unloading section with respect to the storage portion 4a, motors 4f and 4g for driving the rollers 4b and 4e, respectively, and a plurality of sensors (in this embodiment, three pairs of optical sensors 4h, 4i, and 4j) for monitoring the amount of slack of the web 1 in the storage portion 4a, and controls the rotational speeds of the rollers 4b and 4e via the motors 4f and 4g according to the particular output of each sensor so that the amount of slack of the web 1 in the storage portion 4a is restricted to stay within a predetermined allowable range. wherein it is desirable that the roller 4e and the motor 4g be provided so as to keep constant the torque generated and conduct stable control of the torque required for the rotation of the roller 4e.

In the vicinity of the rollers 4d and 4e located at the web unloading section of the buffer unit 4 is provided a guide member 4k that restricts the edge positions of the web 1 fed, wherein, since the guide member 4k acts on the web existing under a stack status, the traveling position of the web 1 in contact with the guide member 4k is easily adjusted. In this embodiment, the guide member 4k is provided so that the skewing width in the feed direction of the web can be restrained with a maximum margin of about 1 mm during the start of feed (this margin during stabilized feed can be about 0.5 mm). The tension of the web 1 at the initial phase of its feed is determined by the torque generated at the roller 4e and the take-up angle of the web with respect to guide roller (fixed roller) 5, and the lateral skew angle of the web can be restrained to a certain extent.

After web 1 has been pulled out from the buffer unit 4, the web is fed into a tension assigning unit 6 via the guide roller 5 mentioned above. The tension assigning unit 6 consists of an infeed roller 6c driven by a motor 6a and a gear 6b, a pressure roller 6d provided so as to be press-fittable against the infeed roller 6c, and a dancer roller 6e supported movably on the web feed route.

The foregoing pressure roller 6d is provided at one end of an arm 6f supported so as to permit its oscillation about a shaft 6g, and is pressed against the infeed roller 6c by the elastic force of a spring 6h provided at the other end of the arm 6f. The dancer roller 6e is provided at one end of an arm 6j supported so as to permit its oscillation about a shaft 6i, and is constructed so that any slight differences in the feed rate of the web being fed are absorbed by the elastic force of a spring 6k provided at the other end of the arm 6j. The oscillating position of the arm 6j is monitored by a sensor 6m, and the rotation of the infeed roller 6c is controlled according to the particular position of the arm 6j, namely, the particular output level of the sensor 6m. In the present invention, the dancer roller 6e plays an important role in controlling the tension of the web 1 between the infeed roller 6c and an outfeed roller 15c (described in detail later in this document). That is to say, an image forming section 10 intervenes between the infeed roller 6c and the outfeed roller 15c, and this means that if highly accurate tension control cannot be conducted at the dancer roller 6e, the printer will pose the fatal problem that image components of each color are transferred under a position-offset status on the web. In this embodiment, therefore, the tension of the web 1 between the infeed roller 6c and the outfeed roller 15c is adjusted by the dancer roller 6e so as to stay within the range from 30 to 200 N, depending on the ream weight and width of the print paper.

After that, the web 1 that was pulled out from the tension assigning unit 6 is fed into a skew correction unit 8 via a guide roller 7. The skew correction unit 8 is composed of two position-restricting rollers 8a and 8b provided in parallel, a sensor 8c for detecting the edge position of the web 1, and a driving motor 8d. The two position-restricting rollers 8a and 8b are supported so that they can be rotationally moved under their parallel status by a frame 8d, and these rollers are provided so that both can be inclined together to the required angle by rotating the frame 8d through an angle based on the output level of the sensor 8c.

The web 1 that has been passed through the skew correction unit 8 is fed into the image forming section 10 via a guide roller 9. Although the present invention does not limit the use of the image forming section 10, this embodiment exemplifies an image forming section of the type which forms toner images on the photosensitive material by use of known electrophotographic processes, and shows the configuration where color images are formed on one side of the web 1 by four imaging portions, 10a, 10b, 10c, and 10d.

The structure of the imaging portions is described below taking imaging portion 10a as an example. Numeral 101 in the figure denotes a photosensitive material belt. When the photosensitive material belt 101 starts rotating, a high voltage is applied to a corona charger 102 and the surface of the photosensitive material belt 101 is uniformly charged. The laser beam that has been emitted from a light source 103 including a semiconductor laser, photoemitting diodes, etc., provides the surface of the photosensitive material belt 101 with image exposure and forms an electrostatic latent image on the photosensitive material belt 101. When the photosensitive material belt area holding this latent image reaches a position that faces a image developing unit 104, a developing agent is supplied to the electrostatic latent image and a toner image is formed on the photosensitive material belt 101. The toner image that has been formed on the photosensitive material belt 101 is attracted onto web 1 by the action of a transfer unit 105 by which a charge of opposite polarity to that of the toner image is assigned to the reverse side of web 1. The area that has passed the transfer position of the photosensitive material belt 101 is cleaned by a cleaning unit 106 in order to prepare for the next printing operation.

After, in the way described above, the toner image has been transferred from the four imaging portions, 10a, 10b, 10c, and 10d, to web 1, the toner image is fixed by the passage of the web through a heater 11 and the web is unloaded from the printer via guide rollers 12, 13, and 14, an outfeed roller mechanism 15, and a puller 16. After this, the web is carried to a post-processor (not shown in the figure), where the printer then performs the required processes, such as cutting, stapling, and punching, on the web in order to complete the series of operations. In this embodiment, the outfeed roller mechanism 15 is constructed similarly to the infeed roller mechanism mentioned earlier in this document, and consists of an infeed roller 15c, which is driven by a motor 15a and a gear 15b, and a pressure roller 15d, which is provided press-fittably with respect to the infeed roller 15c, wherein the pressure roller 15d is provided at one end of an arm 15f supported so as to permit its oscillation about a shaft 15e, and is pressed against the infeed roller 15c by the elastic force of a spring 15g provided at the other end of the arm 15f.

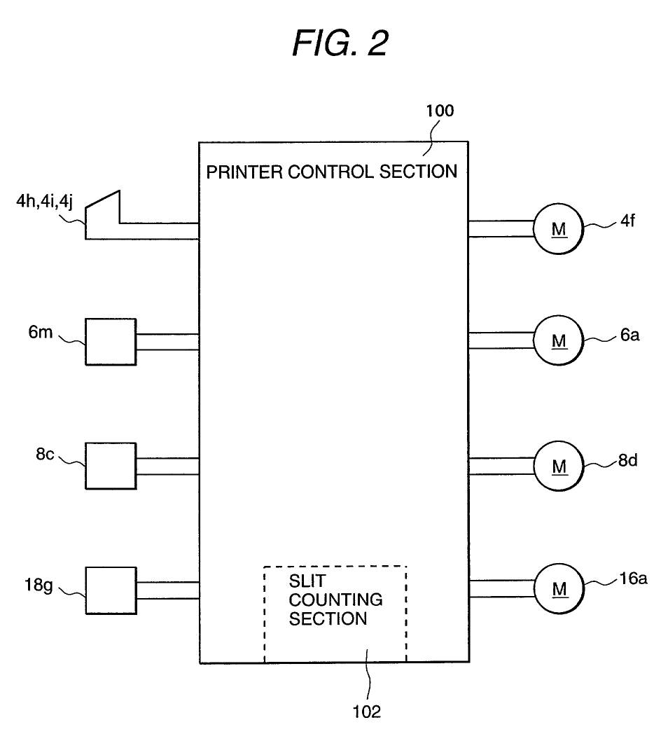

The printer in this embodiment is controlled by a control section 100. How the loop feed motor 4f, the infeed motor 6a, the driving motor 8d of the skew correction unit 8, and the outfeed motor 15a are controlled by the control section 100 is described below using FIG. 2.

The loop feed motor 4f is driven so that its rotational speed changes according to the particular area of a print paper separating sensor on the basis of the digital signals of loop buffer storage volume monitoring switches (for example, optical sensors) 4h and 4j.

The infeed motor 6a has its rotation controlled according to the particular notch position of an encoder 6m provided at the dancer roller 6e, and is driven so as to keep the position of the dancer roller 6e (that is to say, the tension of the print paper) constant.

The driving motor 8d of the skew correction unit 8 is driven according to the particular output level of the paper edge detection sensor 8c, and controls the position of the paper unloaded from the skew correction unit 8. Thus, the position of the paper fed to the image forming unit 10 is maintained stably.

The number of slits in the encoder 18g of a speed detection roller 18 during a fixed time is counted by a slit counting section 102. The speed of the outfeed motor 15a is changed according to the particular count value in order to minimize the effects of the constriction of the paper at fixing section 11 and the effects of increases in the circumferential speed of the outfeed roller 15c, associated with the heating of the outfeed roller. That is to say, the effects of the heat generated by the fixing section 11 can be suppressed by changing the speed of the outfeed motor 15a.

The heater 11 has a plurality of heating plates so that it can supply thermal energy to web 1, and this heater maintains its internal air temperature in the range from 150 to 350 degrees C. and heats the web 1. If the image forming section uses ink jet processing, not electrophotographic processing, the heater 11 can be used as a means of drying the ink image recorded and formed on the web 1 during ink jet processing, and the internal air temperature of the heater 11 in that case is managed to stay within the range from about 40 to 150 degrees C. Numeral 16a in FIG. 1 denotes the motor for driving the roller which constitutes the puller 16, and similarly, numerals 17 and 18 denote the pressure roller and the speed detection roller, respectively, wherein the pressure roller 17 and the speed detection roller 18 are constructed as the so-called “coupled rotating rollers” that rotate simultaneously when coming into contact with the web 1 fed to both. Also, the rotating shaft of the speed detection roller 18 has a slit-provided disc (encoder 18g) and is so constructed as to detect the corresponding slits by use of optical sensors or the like. And the rotational speed of the outfeed roller 15c is controlled by the control section 100 of the printer in accordance with the output signals of the above-mentioned optical sensors within a preset period, and thus the tension of the web passed through the image forming unit 10 is controlled. That is to say, when a signal meaning that the feed status of the web has been detected in its delay direction is obtained from the speed detection roller 18, the rotational speed of the outfeed roller 15c is increased, and in the opposite case, the rotational speed of the outfeed roller 15c is reduced.

According to the printer of the above configuration, since web tension between the infeed roller 6c and the outfeed roller 15c is controlled by the dancer roller 6e and thus the feed of the web 1 passed through the image forming section 10 can be stabilized, high-quality color printing not prone to shifting in terms of image position can be implemented.

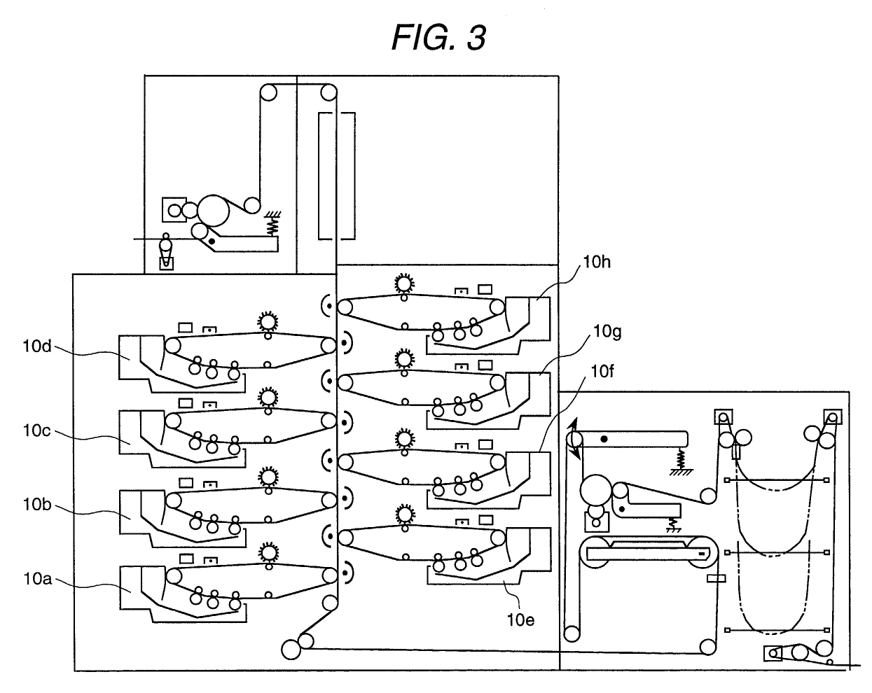

Although the description made above assumes a configuration in which four imaging portions are arranged in line on one side of the web, four imaging portions can also be arranged on the other side of the web to apply the present invention to a printer capable of forming color images on both sides of the web. In this case, arranging at alternately different height levels the four imaging positions provided on one side of the web 1, namely, 10a, 10b, 10c, and 10d, and the four imaging positions provided on the other side of the web 1, namely, 10e, 10f, 10g, and 10h, as shown in FIG. 3, enables the printer to be practical because the height of the printer can be prevented from increasing too greatly and because its design can be made compact.

As set forth above, according to the present invention, high-speed and highly accurate feed of the web passed through the image forming means can be stabilized, irrespective of the web type, since the web printer has

a buffer means for adjusting the traveling position of the web under its slack status,

a tension assigning means for assigning fixed tension to the web delivered from said buffer means,

a means for detecting the traveling position of the web delivered from said tension assigning means,

a skew correction means for adjusting the skew of said web according to the output from said detection means, and

an image forming means that forms images on the web.

What is claimed is:

1. A web printer comprising;
a buffer means for adjusting the traveling position of a web under its slack status,
a tension assigning means for assigning fixed tension to the web delivered from said buffer means,
a means for detecting the traveling position of the web delivered from said tension assigning means,
a skew correction means for adjusting the skew of said web according to the output from said detection means, and
an image forming means that forms an image on the web delivered from said skew correction means.

2. The web printer in claim 1, wherein said image forming means further includes;
a plurality of image forming portions arranged along the web feed route, and
a heating unit that heats the image formed on the web by said image forming portions.

3. The web printer in claim 1, wherein said image forming means further includes;
a plurality of image forming portions arranged on both sides of the web surface along the web feed route, and
a heating unit that heats the image formed on the web by said image forming portions.

4. The web printer in claim 3, wherein said plurality of image forming portions provided on one side of the web surface and the plurality of image forming portions provided on the other side of the web surface are arranged at alternately different height levels.

5. A web printer comprising;
an image forming means that forms an image on a web,
a detection means provided upstream in the feed direction of the web with respect to said image forming means in order to detect at least either one of two factors, namely, the feed distance or feed rate of the web, whichever is the smaller,
an infeed means provided upstream in the feed direction of the web with respect to said detection means in order to control the feed distance of the web according to the output from said detection means so that the tension of the web is fixed, and
an outfeed means provided downstream in the feed direction of the web with respect to said image forming means in order to control the feed distance of the web according to the output from said detection means so that the tension of the web is fixed.

6. A web printer comprising;
a buffer means for adjusting the traveling position of a web under its slack status,
infeed rollers for holding from both sides, and carrying, the web delivered from said buffer means,
a detection means for detecting the traveling position of the web,
a skew correction means for adjusting the skew of the web according to the output from said detection means,
a dancer roller provided between said infeed rollers and said skew correction means,
an infeed roller control means by which the travel of the web fed by said infeed rollers is controlled according to the particular position of said dancer roller in order to obtain fixed web tension,
an image forming means provided at the after-stage of said skew correction means in order to form an image on the web,
a feed rate detection means for detecting the feed rate of the web inducted in aid image forming means, outfeed rollers provided at the after-stage of said image forming means,
and an outfeed roller control means by which the travel of the web fed by said outfeed rollers is controlled according to the particular position of said feed rate detection means in order to obtain fixed web tension.

7. A web printer comprising;
an image forming means that forms an image on a web,
a detection means provided upstream in the feed direction of the web with respect to said image forming means in order to detect at least either one of two factors, namely, the feed distance or feed rate of the web, whichever is the smaller, and
an outfeed means provided downstream in the feed direction of the web with respect to said image forming means in order to control the feed distance of the web according to the output from said detection means so that the tension of the web is fixed.

8. A web printer comprising;
an image forming means that forms an image on a web,
a detection means provided upstream in the feed direction of the web with respect to said image forming means in order to detect at least either one of two factors, namely, the feed distance or feed rate of the web, whichever is the smaller, and
an infeed means provided upstream in the feed direction of the web with respect to said detection means in order to control the feed distance of the web according to the output from the detection means so that the tension of the web is fixed.

9. A web printer for image forming on webs comprising;
a first surface printing means which further has a no-end movably supported belt photosensitive material and at least two image forming portions forming a toner image on the first side of the web fed,
a second surface printing means which further has a no-end movably supported belt photosensitive material and at least one image forming portion forming a toner image on the second side of the web,
and a fixing means by which the toner images formed on both sides of the web are fixed thereon,
and in that not only the belt photosensitive material of said first surface printing means and that of said second surface printing means are arranged at alternate positions across the web, but also said fixing means is positioned almost directly above said first surface printing means and second surface printing means.
